(19) United States
(12) Patent Application Publication
(10) Pub. No.: US 2009/0012192 A1
(43) Pub. Date: Jan. 8, 2009

(54) Low Scorching Flame Retardants for Colored Polyurethane Foams

(76) Inventors: Barry A. Jacobs, Matthews, NC (US); Theodore Halchak, Upper Montclair, NJ (US); Danielle A. Bright, New City, NY (US); Leslie Bright, New City, NY (US)

Correspondence Address: Dilworth Barrese LLP, 333 Earle Ovington Blvd, Suite 702, Uniondale, NY, 11553, US

(21) Appl. No.: 11/587,617

(22) PCT Filed: Apr. 26, 2005
(86) PCT No.: PCT/US05/14291

§ 371 Date: Feb. 5, 2008

Related U.S. Application Data
(60) Provisional application No. 60/565,858, filed on Apr. 27, 2004.

(51) Int. Cl. C08J 9/00

(52) U.S. Cl. 521/55

(57) ABSTRACT

Flame retarded, colored polyurethane foam compositions having reduced discoloration, said foam compositions comprising a foam, which is the reaction product of a polyol and an isocyanate, a colorant, a flame retardant of the type that normally causes scorch and a benzofuranone derivative, as an anti-scorch stabilizer.

### CROSS-REFERENCE TO RELATED APPLICATIONS

This application claims the benefit of Provisional U.S. Patent Application Ser. No. 60/565,858, filed Apr. 27, 2004, the entire contents of which are incorporated by reference herein.

### BACKGROUND OF THE INVENTION

The present invention relates to the combination of a flame retardant of the type that normally give rise to scorching problems in polyurethane foams and a lactone stabilizer, which combination, when incorporated in a polyurethane foam that contains a colorant, such as an insoluble pigment or certain dyes, results in a considerable reduction in the discoloration (also referred to as “scorch”) of that polyurethane foam without impacting the true color of the foam as compared to when only a flame retardant component is employed.

Pigments, polymeric colorants and dyes are traditionally used to color polyurethane foams. Pigments are finely divided solids that are usually dispersed in a liquid medium. They are insoluble and essentially physically and chemically unaffected by the vehicle or the medium in which they are incorporated. Dyes are colored substances that are soluble during the application process.

Polyurethane foams are made by the reaction (or polymerization) of aromatic isocyanates and aliphatic polyols. The process involves the simultaneous polymerization of these reagents and the expansion of the resulting polymer by blowing agents, such as chlorofluorocarbons (CFC's). Because this process is highly exothermic, it often causes the development of scorch, which is an undesirable discoloration in the center of the flexible polyurethane foam bun. Efforts to reduce the use of CFC blowing agents for foaming by increasing the water content leads to even higher exotherms and therefore increased scorch generation. In addition to the reduction of the foam's aesthetic value, scorch adversely affects key physical properties such as tensile and tear strength, elongation and compression set.

During commercial flexible polyurethane foam processing such scorching may occur in the center of the foam buns. This scorching is usually observed when the bun is cut open about one hour after reaching its maximum exotherm. The propensity to scorch escalates with increasing exotherm temperature, which, in turn, is dependent on the water level used in the formulation. As the water level is increased from, for example, 3.5 to 5.0 parts per hundred polyol (php), the exotherm may increase from 130° C. to 170° C. (foam line temperature). The susceptibility for scorching of the foam bun is increased by the addition of certain flame retardants, for example, certain haloalkyl phosphates and certain brominated flame retardants, as well as others, into the formulation.

Scorch that usually occurs at the center of the foam is most likely to occur in slabstock foams. Due to the low thermal conductivity of flexible foams, the heat is likely to disperse slowly. This seems to happen more readily in high water formulations and with the use of auxiliary blowing agents.

As described before, the addition of flame retardants increase the level of scorch produced in the foam. A number of approaches have been used to reduce discoloration. In U.S. Pat. No. 5,182,193 (Dow Chemical) hindered phenolic antioxidants are descried for that purpose. U.S. Pat. No. 5,422,415 (Ciba Geigy Corp.) describes the use of a combination of a benzofuranone additive, an amine antioxidant and a hindered phenolic. Vitamin E (alpha or beta tocopherol) together with octyl diphenyl amine is described for use by Bayer in U.S. Pat. No. 5,695,689. U.S. Pat. No. 5,130,360 (Rhein Chemie Rheinau) claims the use of an aromatic carbodiimide and a benzohydroquinone to prevent polyester urethane discoloration and to reduce hydrolytic degradation. U.S. Pat. No. 5,859,565 (Ciba Specialty Chemicals) describes the combination of polyether polyol(s), a benzofuranone derivative, and at least one phenolic antioxidant and/or at least one secondary amine type antioxidant. All these approaches result in an improvement in the appearance of the foam.

### BRIEF SUMMARY OF THE INVENTION

The present invention relates to flame retarded polyurethane foams which contain colorant. The invention involves the use of a combination of benzofuranone derivative (of the type described in previously mentioned U.S. Pat. No. 5,869,565) and a flame retardant of the type that normally gives rise to scorching problems in the presence of a colorant, such as a pigment or dye, used in the manufacture of the polyurethane foam.

In accordance with the present invention, it has been surprisingly found that when the flame retardant composition of the present invention is utilized in the manufacture of polyurethane foam containing pigments and certain dyes, the resulting foams have considerably reduced discoloration (scorch) without impact to the true color of the foam as compared with colored foams which utilize only the flame retardant component. Furthermore, in accordance with the present invention, it is unnecessary to employ the antioxidants, such as phenolics and amines, disclosed in the prior art in order to obtain the considerable reduction in discoloration achieved herein.

### DETAILED DESCRIPTION

The benzofuranone derivatives useful in the practice of the present invention include those having the formula:

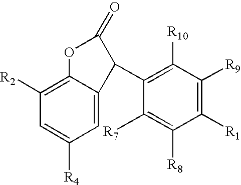

wherein either

two of R₁, R₇, R₈, R₉ and R₁₀ are each independently of the other C₁-C₄ alkyl, the others being hydrogen, or

R₇ to R₁₀ are hydrogen, or at most two of these radicals are each independently of the other methyl, and R₁ is

−O—CHR₃—CHR₅—O—CO—R₆,
R₂ and R₄ are each independently of the other hydrogen or C₁-C₆ alkyl,

R₃ is hydrogen or C₁-C₄ alkyl,

R₅ is hydrogen, phenyl or C₁-C₆ alkyl, and R₆ is C₁-C₄ alkyl.

Specific compounds within the above formula include 5,7-di-t-butyl-3-(3,4 dimethylphenyl)3H-benzofuranone-2-one, which is also preferred herein.

The amount of benzofuranone derivative that is used to accomplish the objectives of the present invention may vary, for example, from about 0.05% to about 5% by weight, based on the total weight of flame-retardant. Preferably, the benzofuranone derivative is employed at about 1% by weight, based on the total weight of flame retardant.

Examples of flame retardants for use in the practice of the present invention include, for example, haloalkyl phosphates, including chloroalkyl phosphate esters, such as tris(dichloroisopropyl) phosphate, e.g., tris(1,3-dichloroisopropyl) phosphate, and tris(chloropropyl phosphate), oligomeric chloroalkyl phosphates (such as AB 100 brand from Rhodia) and the like and oligomeric alkyl phosphates. These materials can be employed alone or in combination with triaryl phosphates, such as butylated triphenyl phosphate, isopropyl triphenyl phosphate and the like and/or with oligomeric aryl phosphates, such as resorcinol bis(diphenyl phosphate), bisphenol A bis(diphenyl phosphate), neopentylglycol bis(diphenyl phosphate) and the like and/or with haloalkyl phosphates.

A second category of halogenated flame retardant for use herein are the brominated flame retardants. They include brominated aryl esters, such as esters of tetrabromobenzoic acid. These materials can be employed alone or in combination with triaryl phosphates (such as the propylated, butylated triphenyl phosphates) and the like and/or with oligomeric aryl phosphates, such as, resorcinol bis(diphenyl phosphate), bisphenol A bis(diphenyl phosphate, neopentylgylcol bis(diphenyl phosphate), and the like. This class of brominated materials also include brominated alkyl products, such as dibronioneopentyl glycol, tribromoeopentyl alcohol and the like. These materials can be employed alone or in combination with triaryl phosphates (propylated, butylated triphenyl phosphates) and the like and/or with oligomeric aryl phosphates, such as, resorcinol bis(diphenyl phosphate), bisphenol A bis((diphenyl phosphate), neopentylglycol bis(diphenyl phosphate) and the like).

Amounts of flame retardant used in the practice of the present invention may vary, but typically include amounts ranging from about 3 to about 30 parts per 100 parts of polyol, preferably from about 7 to about 20 parts per 100 parts of polyol, used in the preparation of the polyurethane foam.

Generally, examples of pigments which may be utilized in the manufacture of colored polyurethane foams include organic pigments, such as azo compounds (red, yellow, orange), phthalocyanines (blue and green), alizarines, flavanthrone and disazo pigments, such as pyrazolone and the like and inorganic pigments, such as carbon black, iron oxide, mixed metal oxides and the like. More specific examples of pigments used in the manufacture of colored polyurethane foams include:

| Pigment | Glass |
|---|---|
| Pigment Red 48:2 | BONA Lakes |
| Pigment Violet 23 | Dioxazine |
| Pigment Yellow 14 | Disazo, diarylide |
| Pigment Orange 16 | Disazo, diarylide |
| Pigment Blue 15:3 | Cu-phthalocyanime, β-form |
| Pigment Red 53:1 | Ba salt of a monoazo acid dye |
| Pigment Red 57:1 | Ca salt of a monoazo acid dye |
| Pigment Red 122 | Dimethyl quinacridone |
| Pigment Violet 19 | Quinacridone (δ-modification-yellowish) |
| Pigment Red 254 | Diketopyrollo-pyrolle |
| Pigment Blue 60 | Anthraquinone (indanthrone) |
| Pigment Green 7 | Chlorinated Phthalocyanine |

Examples of dyes which may be utilized in the manufacture of colored polyurethane foams and to which the present invention is particularly effective include Milliken dyes X-64 Red, X-15 Yellow and X-96 Orange.

Typically, colorants are used in the polyurethane foams in amounts ranging from about 0.1% by weight to about 5% by weight of the total foam formulation.

The invention is further illustrated in the following representative Examples.

### EXAMPLES

### Polyurethane Foam Production

The polyol, colorant, flame-retardant, water, catalysts and silicone were mixed with stirring, in a first beaker. In a separate beaker, the toluene diisocyanate (TDI) was weighed out. The organo-tin catalyst was put into a syringe. The first beaker was stirred at about 2100 revolutions per minute for a period of ten seconds and then the organo-tin catalyst was dosed thereto while stirring was continued. After a total of twenty-one seconds of stirring, the TDI was added to the mixture. Stirring was then continued for an additional nine seconds, and the still fluid mixture was quickly put into an 8″×8″×5″ box. Then the cream and rise times were measured. Once the foam ceased to rise, it was placed in a forced air oven which is set to 115 for 8 minutes. After 8 minutes, the foam is removed from the oven. After cooling, the top of the foam is cut at the base of the crest. A second cut is made ¾″ below the first cut giving a foam sample of ¾″ thickness. All foam evaluations are done by comparing the ¾″ foam standard to the ¾″ foam cut of the batch check.

| Formulation | Grams |
|---|---|
| 53 OH Ether Polyol Resin | 100.0 |
| Fyrol ® FR-2 + 1% HP-136 | 10.0 |
| Colorant | 1.0 |
| Air Products DABCO T-9 | 0.30 |
| Air Products DABCO 33LV | 0.20 |
| Air Products DABCO BL17 | 0.10 |
| OSI L-620 silicone | 1.30 |
| Toluene diisocyanate | 44.0 |
| NCO index | 110 |

HP-136 brand stabilizer is available from Ciba Specialty
Chemicals is 5,7-di-t-butyl-3-(3,4 di-methylphenyl) 3H-benzofuran-2-one (CAS Number of 181314-48-7).
Fyrol ® brand flame retardant, available from Supresta LLC, is tris(1,3-dichloroisopropyl)phosphate

### Visual Pass/Fail Criteria

Pass (Strength): The specified relative tinting strength of a batch foam is +/−10% to standard. This is evaluated by comparing strengths side-by-side to the standard. If there is a <10% visual difference in strength, the product passes for strength.

### Results

| Foam Containing | Strength |
|---|---|
| Fyrol FR-2 + 1% HP-136 + 1 php Dye X-15 Yellow | Pass |
| Fyrol FR-2 + 1% HP-136 + 1 php Dye X-96 Orange | Pass |
| Fyrol FR-2 + 1% HP-136 + 1 php Pigment Red 48:2 | Pass |
| Fyrol FR-2 + 1% HP-136 + 1 php Pigment Violet 23 | Pass |
| Fyrol FR-2 + 1% HP-136 + 1 php Pigment Yellow 14 | Pass |
| Fyrol FR-2 + 1% HP-136 + 1 php Pigment Blue 15:3 beta | Pass |
| Fyrol FR-2 + 1% HP-136 + 1 php Pigment Green 7 | Pass |

The above data show the consistency of the foam strength obtained with pigments and some dyes. The above data further show that the benzofuranone derivative (HP-136) does not have an adverse effect on the colorants.

The foregoing examples illustrate certain embodiments of the present invention and for that reason should not be construed in a limiting sense. The scope of protection that is sought is set forth in the claims that follow.

What is claimed is:

1. A flame retarded, colored polyurethane foam composition having reduced discoloration, said foam composition comprising a foam, which is the reaction product of a polyol and an isocyanate, a colorant, a flame retardant of the type that normally causes scorch and a benzofuranone derivative, as an anti-scorch stabilizer.

2. The composition of claim 1 wherein the colorant is a pigment.

3. The composition of claim 1 wherein the colorant is a dye.

4. The composition of claim 1 wherein said benzofuranone derivative is a compound having the formula 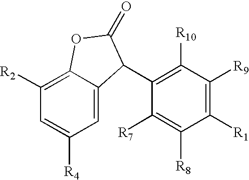
wherein either
two of R₁, R₇, R₈, R₉ and R₁₀ are each independently of the other C₁-C₄ alkyl, the others being hydrogen, or
R₇ to R₁₀ are hydrogen, or at most two of these radicals are each independently of the other methyl, and R₁ is
—O—CHR₃—CHR₅—O—CO—R₆,
R₂ and R₄ are each independently of the other hydrogen or C₁-C₆ alkyl,
R₃ is hydrogen or C₁-C₄ alkyl,
R₅ is hydrogen, phenyl or C₁-C₆ alkyl, and
R₆ is C₁-C₄ alkyl.

5. The composition of claim 4 wherein the benzofuranone derivative is 5,7-di-t-butyl-3-(3,4 dimethylphenyl)3H-benzofuranone-2-one.

6. The composition of claim 1 wherein the flame retardant is a chloroalkyl phosphate.

7. The composition of claim 6 wherein the chloroalkyl phosphate is tris(1,3-dichloroisopropyl) phosphate.

8. The composition of claim 1 wherein the flame retardant is a brominated compound.

9. The composition of claim 8 wherein the brominated compound is an ester of tetrabromobenzoic acid.

10. The composition of claim 1 wherein said flame retardant is a blend of flame retardants.

11. The composition of claim 10 wherein the blend of flame retardants comprises a chloroalkyl phosphate and a triaryl phosphate.

12. The composition of claim 10 wherein the blend of flame retardants comprises a brominated compound and triaryl phosphate.

13. The composition of claim 12 wherein the brominated compound is an ester of tetrabromobenzoic acid.
